(19) United States
(12) Patent Application Publication
(10) Pub. No.: US 2025/0202180 A1
(43) Pub. Date: Jun. 19, 2025

(54) PLANE SLIP RING, ROTATING CONDUCTIVE ASSEMBLY AND TELESCOPIC DATA CABLE ASSEMBLY

(71) Applicant: Dongguan Ceesing Intelligent Device Manufacturing Co., Ltd, Dongguan (CN)

(72) Inventor: Zhanxing LIN, Dongguan (CN)

(73) Assignee: Dongguan Ceesing Intelligent Device Manufacturing Co., Ltd, Dongguan, GD (CN)

(21) Appl. No.: 19/063,360

(22) Filed: Feb. 26, 2025

Related U.S. Application Data
(63) Continuation-in-part of application No. PCT/CN2023/135230, filed on Nov. 29, 2023.

(30) Foreign Application Priority Data
Dec. 12, 2022 (CN) 202211590092.4
Dec. 12, 2022 (CN) 202223330313.2
Apr. 12, 2023 (CN) 202310393398.9

(51) Int. Cl. H01R 39/64

(52) U.S. Cl. CPC H01R 39/64

(57) ABSTRACT

A plane slip ring, a rotating conductive assembly and a telescopic data cable assembly are provided. The plane slip ring includes a structural support and a plurality of conductive members arranged on the structural support. The structural support includes a limit ring and an extension section formed by radially symmetrical extension of the limit ring. The conductive member is arranged on the extension section, including a contact portion formed with contact points, and each contact point of the conductive member is in the same straight line. The symmetrically arranged extension sections can keep the forces at both ends balanced during rotation, thereby reducing the wear of the plane slip ring and improving the service life. The contact portion is convenient for abutting against other components, and the contact points are in the same straight line to ensure the overall coaxiality, making the rotation process more stable.

### TECHNICAL FIELD

The present disclosure relates to the technical field of electronic accessories, and in particular to a plane slip ring, a rotating conductive assembly and a telescopic data cable assembly.

### BACKGROUND

Current plane slip rings exhibit a range of structural designs. However, during their operation and rotation, certain configurations may lead to a decrease in the coaxial alignment of the conductive components, resulting in uneven force distribution. This phenomenon adversely impacts both the conductive performance and the rotational stability of the slip rings.

### SUMMARY

In order to solve the problem of poor coaxiality of conductive members in plane slip rings, a plane slip ring, a rotating conductive assembly and a telescopic data cable assembly is provided in the present disclosure.

To solve the technical problem above, a plane slip ring is provided to ensure a stable electrical connection with a PCB board during rotation. The plane slip ring includes a structural support and a plurality of conductive members arranged on the structural support. The structural support includes a limit ring and an extension section extending radially symmetrically along the limit ring, and the conductive member is arranged on the extension section. The conductive member includes a contact portion for electrical contact with other external components, a contact point is formed on the contact portion, and each contact point of the conductive member is coplanar and located on the same straight line.

Preferably, the extension section includes at least two sections, which are axially symmetrical or centrally symmetrical on both sides of the limit ring.

Preferably, the total quantity of the extending sections is an even number.

Preferably, the conductive members are evenly spaced and arranged on the same side of the extending section along the axial direction of the limit ring.

Preferably, the conductive members are symmetrically arranged on the extension section.

Preferably, the plane slip ring further includes a plurality of pins electrically connected to the conductive members, and the extension section is provided with a plurality of receiving grooves for accommodating the conductive members and the pins.

Preferably, the conductive members and the pins are embedded in the receiving grooves and both partially protrude from the receiving groove.

Preferably, one end of the conductive member is embedded in the receiving groove, and the other end thereof is overhead with the contact portion. The overhead end of the conductive member is received in the receiving groove.

Preferably, each pair of pins and conductive members that are electrically connected are integrally formed or spliced together.

Preferably, the conductive member is partially bent to form the contact portion, and an abutment structure is arranged on a curved surface of each contact portion. The abutment structure forms the contact point at a position where the curved surface is in electrical contact with other external components.

Preferably, the contact portion is in the form of an arc, the arc is bent away from the extending section, and the abutment structure is arranged on an arc surface of each contact portion.

Preferably, one side of the limit ring close to the conductive member protrudes from the structural support, and the protruding height thereof is less than the height of the vertex of the contact portion of the conductive member.

Preferably, an annular protrusion that forms a concentric ring structure with the limit ring is provided on a side of the limit ring away from the conductive member forming the contact portion.

Preferably, the outer diameter of the annular protrusion is less than the outer diameter of the limit ring.

Preferably, the side wall defining the limit ring and the annular protrusion close to the conductive member is an outer side wall, and the side wall defining the limit ring and opposite to the outer side wall is an inner side wall. The inner side wall of the annular protrusion is in the same plane as the inner side wall of the limit ring, and the thickness between the inner and outer side walls of the annular protrusion is less than the thickness between the inner and outer side walls of the limit ring. The annular protrusion is arranged close to the inner side wall of the limit ring, such that the inner side wall of the annular protrusion and the inner side wall of the limit ring are in the same plane.

Preferably, the structural support is further provided with a partition plate, and the partition plate is used to limit the interval at which the conductive members are arranged and the position of the limit ring and the conductive member.

To solve the technical problem above, a rotating conductive assembly is further provided, which includes the plane slip ring and a limit plate adapted to the plane slip ring, where the limit plate is provided with a limit protrusion adapted to the limit ring, and the plane slip ring can complete rotation through cooperation between the limit ring and the limit protrusion.

Preferably, the limit plate comprises a first limit plate and a second limit plate, and the plane slip ring is arranged on the second limit plate and rotates in cooperation with the first limit plate via the limit ring.

Preferably, the first limit plate is provided with a slide groove corresponding to the contact portion of the conductive member, the slide groove is formed along a rotation trajectory of a corresponding conductive member, and the conductive member abuts against and is electrically connected to a bottom of the slide groove.

To solve the technical problem above, a telescopic data cable assembly is further provided, which includes the rotating conductive assembly, and the telescopic data cable assembly further includes a data cable electrically connected to the rotating conductive assembly. When the data cable is stretched, the plane slip ring in the rotating conductive assembly is driven to rotate.

Compared with the prior art, the plane slip ring, the rotating conductive assembly and the telescopic data cable assembly of the present disclosure has the following advantages.

In the present disclosure, the plane slip ring includes a structural support and a plurality of conductive members arranged on the structural support. The structural support includes a limit ring and an extension section extending radially symmetrically along the limit ring, and the conductive member is arranged on the extension section. The conductive member includes a contact portion for electrical contact with other external components, a contact point is formed on the contact portion, and each contact point of the conductive member is coplanar and located on the same straight line. Thus, the limit ring can limit the position of the plane slip ring and can rotate around the limit ring. The symmetrically arranged extension section can maintain balanced forces at both ends thereof during rotation, thereby reducing the wear of the plane slip ring when interacting with other components and increasing the service life. The contact portion of the conductive member is convenient for abutting against other components, and the contact points of the contact portions are in the same straight line to ensure the overall coaxiality, making the rotation process of the plane slip ring more stable.

In the present disclosure, the extension section is at least two sections, which are axially symmetrical or centrally symmetrical on both sides of the limit ring. Thus, the conductive members are symmetrically and spaced apart on the extension sections, and the extension sections are axially symmetrically and centrally symmetrically arranged on both sides of the limit ring. When working, the conductive members on the extension sections will abut against and slide relatively with other components, and the friction forces received are the same, thereby ensuring the balance and stability of the rotation of the plane slip ring.

In the present disclosure, the conductive members are evenly spaced and arranged on the same side of the extending section along the axial direction of the limit ring. Thus, when the conductive members on the extension sections rotate, the line connecting the contact points and the center of rotation are always on the same straight line, further ensuring the balance and stability of the plane slip ring during rotation.

In the present disclosure, the plane slip ring further includes a plurality of pins electrically connected to the conductive member, and the extension section is provided with a plurality of receiving grooves for accommodating the conductive member and the pins. The pin and the conductive member form a simple circuit loop, the pin is used to electrically connect to a data cable to obtain electrical signals and transmit the electrical signals through the conductive member or receive electrical signals transmitted by components or devices electrically connected to the conductive member and transmit them to the data cable. The receiving groove limits the conductive members and the pins, preventing the plane slip ring from loosening or even falling off during rotation, resulting in reducing functionality or even being scrapped.

In the present disclosure, the conductive member and the pin are embedded in the receiving groove and both partially protrude from the receiving groove. Thus, the conductive member and the pin are embedded in the receiving groove, the receiving groove can fix the conductive member and the pin and is convenient for replacement when the conductive member and the pin are used for a long time or the components are excessively worn. The structure is simpler and the production and processing are more convenient.

In the present disclosure, the conductive member is partially bent to form the contact portion, and an abutment structure is arranged on a curved surface of each contact portion. The abutment structure forms the contact point at a position where the curved surface is in electrical contact with other external components. Thus, the contact portion of the conductive member can be easily abutted against other components, and the abutting structure can serve as an intermediate layer to connect the conductive member and abut against other components, thereby enhancing contact, reducing impedance, and ensuring better conductive performance.

In the present disclosure, the contact portion is in the form of an arc, the arc is bent away from the extending section, and the abutment structure is arranged on an arc surface of each contact portion. The arc-shaped contact portion can reduce a certain contact area, and the contact surface is smoother, thereby ensuring the smoothness of the conductive member during the sliding process, and making the rotation process of the plane slip ring more stable.

In the present disclosure, one side of the limit ring close to the conductive member protrudes from the structural support, and the protruding height thereof is less than the height of the vertex of the contact portion of the conductive member. The protruding configuration of the limit ring can increase the engagement area between the inner wall of the limit ring and other structures, thereby better limiting the position of the limit ring to prevent it from loosening due to loose engagement during operation. The limitation on the protruding height can prevent the interface of the protruding part thereof from contacting other structures to form friction, increase the smoothness of use, prevent wear, and ensure the service life of the plane slip ring.

In the present disclosure, an annular protrusion that forms a concentric ring structure with the limit ring is provided on a side of the limit ring away from the conductive member forming the contact portion. Thus, the annular protrusion can be matched and connected with other components to further ensure the stability of the connection.

In the present disclosure, the outer diameter of the annular protrusion is less than the outer diameter of the limit ring, which makes the overall structure simpler, and the annular protrusion can cooperate with other components to further limit the position, and the stability of the connection is increased.

In the present disclosure, the rotating conductive assembly includes the above-mentioned plane slip ring and a limit plate adapted to the plane slip ring, the limit plate is provided with a limit protrusion adapted to the limit ring, and the plane slip ring can complete the rotation through the cooperation between the limit ring and the limit protrusion. The rotating conductive assembly has the same beneficial effects as the above-mentioned plane slip ring, which will not be described in detail here.

In the present disclosure, the first limit plate is provided with a slide groove corresponding to the contact portion of the conductive member, the slide groove is provided along the rotation trajectory of the corresponding conductive member, and the conductive member abuts against and is electrically connected to the bottom of the slide groove. Thus, when the plane slip ring rotates, the conductive member can move in the slide groove and always maintain an electrical connection with the bottom of the slide groove, which is convenient for the transmission of electrical signals.

In the present disclosure, the telescopic data cable assembly includes the rotating conductive assembly as described above, and the telescopic data cable assembly also includes a data cable electrically connected to the rotating conductive assembly. When the data cable is stretched, the plane slip ring in the rotating conductive assembly is driven to rotate. The telescopic data cable assembly has the same beneficial effects as the rotating conductive assembly as described above, which will not be described in detail here.

### BRIEF DESCRIPTION OF DRAWINGS

In order to more clearly illustrate the technical solutions of the embodiments of the present disclosure, the drawings needed to be used in the description of the embodiments will be briefly introduced below. Obviously, the drawings in the following description are some embodiments of the present disclosure. Those of ordinary skill in the art can also obtain other drawings based on these drawings without exerting creative work.

FIG. 1 is a schematic diagram of a perspective structure view of a plane slip ring provided in a first embodiment.

FIG. 2 is a schematic diagram of a structure of a conductive member and a pin of the plane slip ring provided in the first embodiment.

FIG. 3 is another schematic diagram of a structure of the limit ring of the plane slip ring provided in the first embodiment.

FIG. 4 is a third schematic diagram of a perspective structure view of the plane slip ring provided in the first embodiment.

FIG. 5 is a schematic diagram of a perspective structure view of a rotating conductive assembly provided in a second embodiment.

FIG. 6 is a schematic diagram of a conductive circuit of a second limit plate of the rotating conductive assembly provided in the second embodiment.

FIG. 7 is a schematic diagram of a conductive circuit of a first limit plate of the rotating conductive assembly provided in the second embodiment.

FIG. 8 is a schematic diagram of a perspective structure view of a telescopic data cable assembly provided in a third embodiment.

In the drawings, the parts represented by each number are listed as follows:
1. plane slip ring; 2. rotating conductive assembly; 3. telescopic data cable assembly;
11. structural support; 12. conductive member; 13. pin; 21. limit plate; 31. data cable;
111. limit ring; 112. extension section; 121. contact portion; 122. abutment structure; 211. first limit plate; 212. second limit plate;
1111. annular protrusion; 1121. receiving groove; 1122. partition plate; 1123. connecting groove; 1221. contact point; 2111. limit protrusion; 2112. slide groove.

### DETAILED DESCRIPTION

The technical solutions in the embodiments of the present disclosure will be clearly and completely described below with reference to the accompanying drawings in the embodiments of the present disclosure. Obviously, the described embodiments are part of the embodiments of the present disclosure, rather than all of the embodiments. Based on the embodiments in the present disclosure, all other embodiments obtained by those of ordinary skill in the art without creative efforts fall within the scope of protection of the present disclosure.

It should be noted that the terms “first” and “second” and the like in the specification and claims of the present disclosure are used to distinguish different objects rather than to describe a specific order.

It should be noted that when an element is referred to as being “fixed” to another element, it can be directly on the other element or intervening elements may also be present. When an element is referred to be “connected” to another element, it can be directly connected to the other element or there may also be intervening elements present. The terms “vertical,” “horizontal,” “left,” “right,” and similar expressions are used herein for illustrative purposes only.

In the present disclosure, the terms “upper”, “lower”, “left”, “right”, “front”, “rear”, “top”, “bottom”, “inner”, “outer”, “middle”, “vertical”, “horizontal”, “lateral”, “longitudinal” and the like indicate positions or positional relationships based on the positions or positional relationships shown in the accompanying drawings. These terms are mainly used to better describe the present disclosure and its embodiments, and are not used to limit the indicated devices, elements or components to have a specific orientation, or to be constructed and operated in a specific orientation.

In addition, in addition to being used to indicate an orientation or positional relationship, some of the above terms may also be used to indicate other meanings. For example, the term “upper” may also be used to indicate a certain dependency or connection relationship in some cases. For those of ordinary skill in the art, the specific meanings of these terms in the present disclosure can be understood according to the specific circumstances.

In addition, the terms “installed”, “set”, “provided with”, and “connected” should be understood in a broad sense. For example, it can be a fixed connection, a detachable connection, or an integral structure; it can be a mechanical connection or an electrical connection; it can be a direct connection, or an indirect connection through an intermediate medium, or it can be an internal connection between two devices, elements or components. For those of ordinary skill in the art, the specific meanings of the above terms in the present disclosure can be understood according to the specific circumstances.

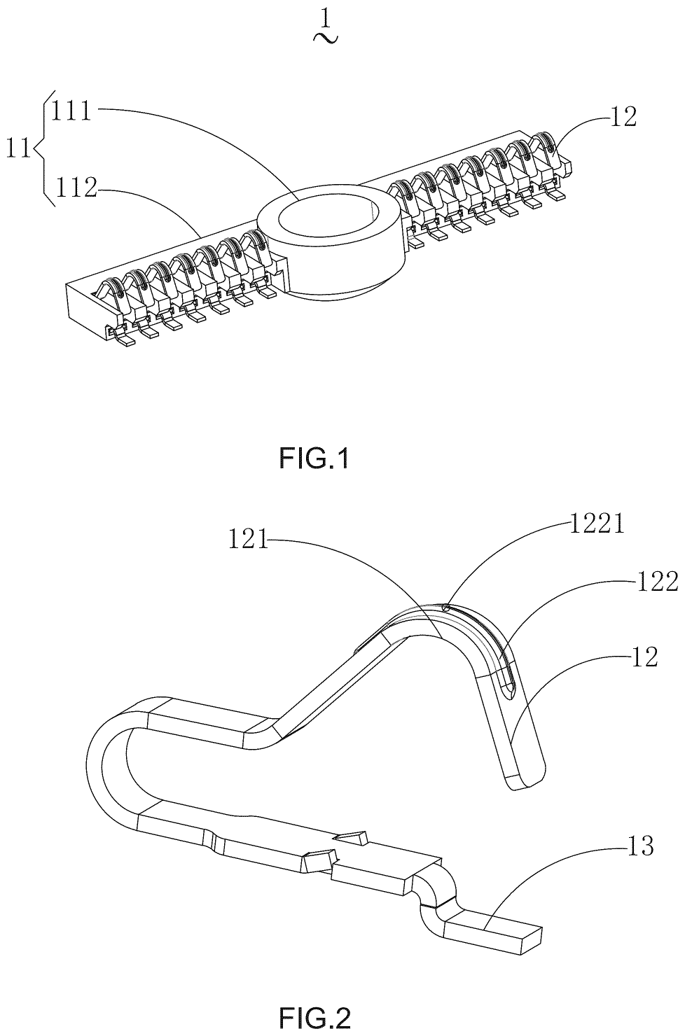

Please refer to FIGS. 1 and 2. A first embodiment of the present disclosure provides a plane slip ring 1 for ensuring a stable electrical connection with a PCB board during rotation. The plane slip ring 1 includes a structural support 11 and a plurality of conductive members 12 arranged on the structural support 11. The structural support 11 includes a limit ring 111 and an extension section 112 extending radially symmetrically along the limit ring 111. The conductive member 12 is arranged on the extension section 112 and includes a contact portion 121 for electrically contacting other external components. The contact portion 121 is formed with a contact point 1211. The contact point 1211 of each conductive member 12 is coplanar and located on the same straight line.

It should be noted that the structural shape of the limit ring 111 is not limited and is not required to be configured as a circular-ring shape. To facilitate rotation, the inner wall of the limit ring 111 is usually circular, which can be abutted with a matching structure to fix the position of the plane slip ring 1 and can rotate while fitting with the inner wall of the limit ring 111.

Specifically, in a specific embodiment of the present disclosure, the limit ring 111 is configured as a circular-ring shape, and there is a certain thickness between the inner and outer walls thereof to ensure the mechanical properties of the limit ring 111. The extension section 112 is integrally formed with the limit ring 111 and extends in opposing directions.

It can be understood that through the above arrangement, the limit ring 111 can limit the position of the plane slip ring 1 and can rotate around the limit ring 111. The symmetrically arranged extension section 112 can maintain balanced forces at both ends thereof during rotation, thereby reducing the wear of the plane slip ring 1 when interacting with other components and increasing the service life. The contact portion 121 of the conductive member 12 is convenient for abutting against other components, and the contact points of the contact portions 121 are in the same straight line to ensure the overall coaxiality, making the rotation process of the plane slip ring 1 more stable.

Further, the extension section 112 includes at least two sections, which are axially symmetrical or centrally symmetrical on both sides of the limit ring 111.

Specifically, the conductive members 12 are evenly spaced and arranged on the same side of the extension section 112.

It should be noted that “the same side” refers to the same side along the axial direction of the limit ring 111, rather than the same side along the radial direction of the extension section 112, that is, the conductive members 12 on the same side of the extension section 112 are preferentially ensured to be coplanar, and then in the case of coplanarity, the coaxiality is ensured by limiting the position of the conductive members 12 and adjusting the contact points 1211. In order to ensure the coaxiality of the conductive members 12 arranged thereon and the balanced stress condition of the overall structure of the plane slip ring 1, the extension sections 112 are symmetrically arranged in pairs, therefore, the total number of the extension sections 112 is not limited and can be an even number. If the coaxiality does not need to be met, the number of the extension sections 112 can be an odd number such as three or five, which meets the central symmetry to balance the stress on the plane slip ring 1.

Specifically, in the embodiment of the present disclosure, the number of the extending sections 112 is two, and the conductive members 12 are arranged on the same side of the extending sections 112 and on the same straight line.

It can be understood that through this arrangement, the conductive members 12 are symmetrically and spaced apart on the extension sections 112, and the extension sections 112 are axially symmetrically and centrally symmetrically arranged on both sides of the limit ring 111. When working, the conductive members 12 on the extension sections 112 will abut against and slide relatively with other components, and the friction forces received are the same, thereby ensuring the balance and stability of the rotation of the plane slip ring 1. In addition, when the conductive members 12 on the extension sections 112 rotate, the line connecting the contact points 1211 and the center of rotation are always on the same straight line, further ensuring the balance and stability of the plane slip ring 1 during rotation.

Further, the conductive member 12 is partially bent to form a contact portion 121, and an abutment structure 122 is provided on the curved surface of the contact portion 121. The abutment structure 122 forms a contact point 1221 at a position where the curved surface is in electrical contact with other external components.

Specifically, the contact portion 121 is in an arc shape, the arc is bent away from the extending section 112, and the abutment structure 122 is disposed on the arc surface of each contact portion 121.

It should be noted that the conductive members 12 are made of metal and can conduct electricity, and the abutment structure 122 is provided to improve the conductivity thereof.

It can be understood that through the above arrangement, the contact portion 121 of the conductive member 12 can easily abut against other components. The arc shape of the contact portion 121 can reduce a certain contact area, and the contact surface is smoother, which ensures the smoothness of the conductive member 12 during the abutment and sliding process, thereby making the rotation process of the plane slip ring 1 more stable. The abutment structure 122 can serve as an intermediate layer to connect the conductive member 12 and abut against other components, thereby enhancing contact, reducing impedance, and ensuring better conductive performance.

Specifically, in a specific embodiment of the present disclosure, the conductive member 12 is a metal spring. In addition, to ensure that the conductive members 12 are on the same straight line, the arcs of the contact portions 121 need to be controlled to have the same specifications, and the centers of the circles of the arcs are on the same straight line, such that the contact points 1221 of each conductive member 12 are at the same height. Specifically, the specifications of the arcs are not limited here and are subject to actual needs.

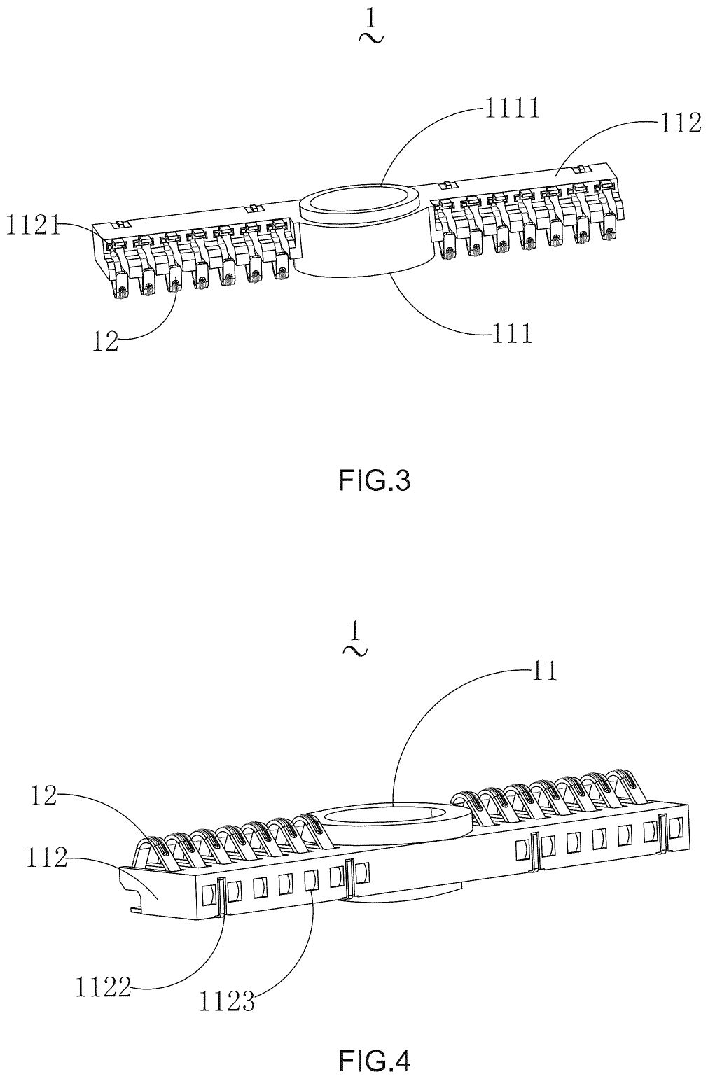

Further, please refer to FIG. 2 and FIG. 3. The plane slip ring 1 further includes a plurality of pins 13 electrically connected to the conductive members 12, and a plurality of receiving grooves 1121 for receiving the conductive members 12 and the pins 13 are formed on the extension section 112.

It should be noted that the pin 13 is connected to one end of the conductive member 12 embedded in the receiving groove 1121, and the pin 13 is jointly embedded in the receiving groove 1121. The receiving groove 1121 can fix the conductive member 12 and the pin 13. The other end of the pin 13 extends from the receiving groove 1121 for connecting a data cable. This ensures the electrical connection between the pin 13 and the conductive member 12 to realize the transmission of electrical signals. In addition, this ensures the firm fixation of the conductive member 12 and the pin 13 to prevent the pin 13 and/or the conductive member 12 from falling off due to external force or friction during use or rotation, which may reduce the service life of the plane slip ring 1.

It can be understood that through the above arrangement, the pin 13 and the conductive member 12 form a simple circuit loop, the pin 13 is used to electrically connect to a data cable to obtain electrical signals and transmit the electrical signals through the conductive member 12 or receive electrical signals transmitted by components or devices electrically connected to the conductive member 12 and transmit them to the data cable.

Specifically, the conductive member 12 and the pin 13 are embedded in the receiving groove 1121 and both partially protrude from the receiving groove 1121.

It should be noted that the receiving grooves 1121 are arranged on the extension section 112 at intervals along with the conductive members 12, and the width of the receiving grooves 1121 corresponds to the width of the conductive members 12.

It can be understood that, through the above arrangement, the conductive member 12 is embedded in the receiving groove 1121, which makes the structure simpler, and the production and processing more convenient.

In addition, one end of the conductive member 12 is embedded in the receiving groove 1121, and the other end thereof is overhead with the contact portion 121. In a specific embodiment of the present disclosure, the overhead end of the conductive member 12 is received in the receiving groove 1121 to protect the conductive member 12 and reduce the space occupancy rate of the conductive member 12.

It can be understood that the arc-shaped overhead portion of the conductive member 12 can effectively and automatically adjust the abutting position and abutting pressure of the conductive member 12 when it abuts against other components.

Further, each pair of electrically connected pins 13 and conductive members 12 are integrally formed or spliced together.

Specifically, a connecting groove 1123 connecting the receiving groove 1121 and the outer side of the structural support 11 is provided on the structural support 11. The connecting grooves 1123 are provided on the opposite side of the extension direction of the pins 13 on the structural support 11. The user can confirm the connection status of the pins 13 and the conductive members 12, as well as the embedded status of the pins 13 and the conductive members 12 in the receiving groove 1121 through the connecting grooves 1123.

Further, refer to FIG. 3 and FIG. 4. The side of the limit ring 111 close to the conductive member 12 protrudes from the structural support 11, and the protruding height thereof is less than the height of the vertex of the contact portion 121 of the conductive member 12.

It can be understood that, through the above arrangement, the stability of the connection between the plane slip ring 1 and other components can be increased, and the height limitation can prevent the limit ring 111 from rubbing against other components, which may affect the smoothness of the rotation of the plane slip ring 1.

Further, an annular protrusion 1111 that forms a concentric ring structure with the limit ring 111 is provided on a side of the limit ring 111 away from the conductive member 12 forming the contact portion 121.

Further, the side wall defining the limit ring 111 and the annular protrusion 1111 close to the conductive member 12 is the outer side wall, and the side wall opposite to the outer wall is the inner side wall. The inner side wall of the annular protrusion 1111 is in the same plane as the inner side wall of the limit ring 111. The diameter between the inner and outer side walls of the annular protrusion 1111 is less than the diameter between the inner and outer side walls of the limit ring 111, that is, the thickness between the inner and outer side walls of the annular protrusion 1111 is less than the thickness between the inner and outer side walls of the limit ring 111.

It should be noted that the annular protrusion 1111 is arranged close to the inner side wall of the limit ring 111, such that the inner side wall of the annular protrusion 1111 and the inner side wall of the limiting ring 111 are in the same plane.

It can be understood that through the above arrangement, the inner side wall of the annular protrusion 1111 and the inner side wall of the limit ring 111 are on the same plane, making the overall structure simpler. The annular protrusion 1111 can cooperate with other components for further limiting, further ensuring the stability of the connection.

Furthermore, a partition plate 1122 is also provided on the structural support 11.

It should be noted that the position of the partition plate 1122 is not limited, as long as it is symmetrically arranged on the extension section 112. Specifically, in a specific embodiment of the present disclosure, the partition plate 1122 is disposed at the position of the first conductive member 12 in the direction in which the extension section 112 extends from the limit ring 111, and is disposed again at intervals of five conductive members 12.

It can be understood that the partition plate 1122 is used to limit the interval of the conductive member 12 and the position of the limit ring 111 and the conductive member 12, as well as add a certain counterweight to ensure the reliability of the plane slip ring 1 during rotation.

Please refer to FIGS. 4 and 5. The present disclosure further provides a rotating conductive assembly 2 to solve the technical problem, including the above-mentioned plane slip ring 1 and a limit plate 21 adapted to the plane slip ring 1. The limit plate 21 is provided with a limit protrusion 2111 adapted to the limit ring 111. The plane slip ring 1 can complete the rotation through the cooperation between the limit ring 111 and the limit protrusion 2111. The rotating conductive assembly 2 has the same beneficial effects as the above-mentioned plane slip ring 1, which will not be described in detail here.

It should be noted that the number of the limit plate 21 is generally configured as two, and the plane slip ring 1 is placed between the two limit plates 21 to assist in rotation or resetting. The limit plate 21 close to the conductive member 12 is as described above, and the limit plate 21 away from the conductive member 12 is designed according to actual needs or the corresponding structure of the plane slip ring 1 to ensure the normal implementation of the function.

Further, the limit plate 21 includes a first limit plate 211 and a second limit plate 212, and the plane slip ring 1 is disposed on the second limit plate 212. The plane slip ring 1 rotates in cooperation with the first limit plate 211 via the limit ring 111.

Further, a slide groove 2112 corresponding to the contact portion 121 of the conductive member 12 is formed on the first limit plate 211 of the rotating conductive assembly 2. The slide groove 2112 is formed along the rotation trajectory of the corresponding conductive member 12. The conductive member 12 abuts against and is electrically connected to the bottom of the slide groove 2112.

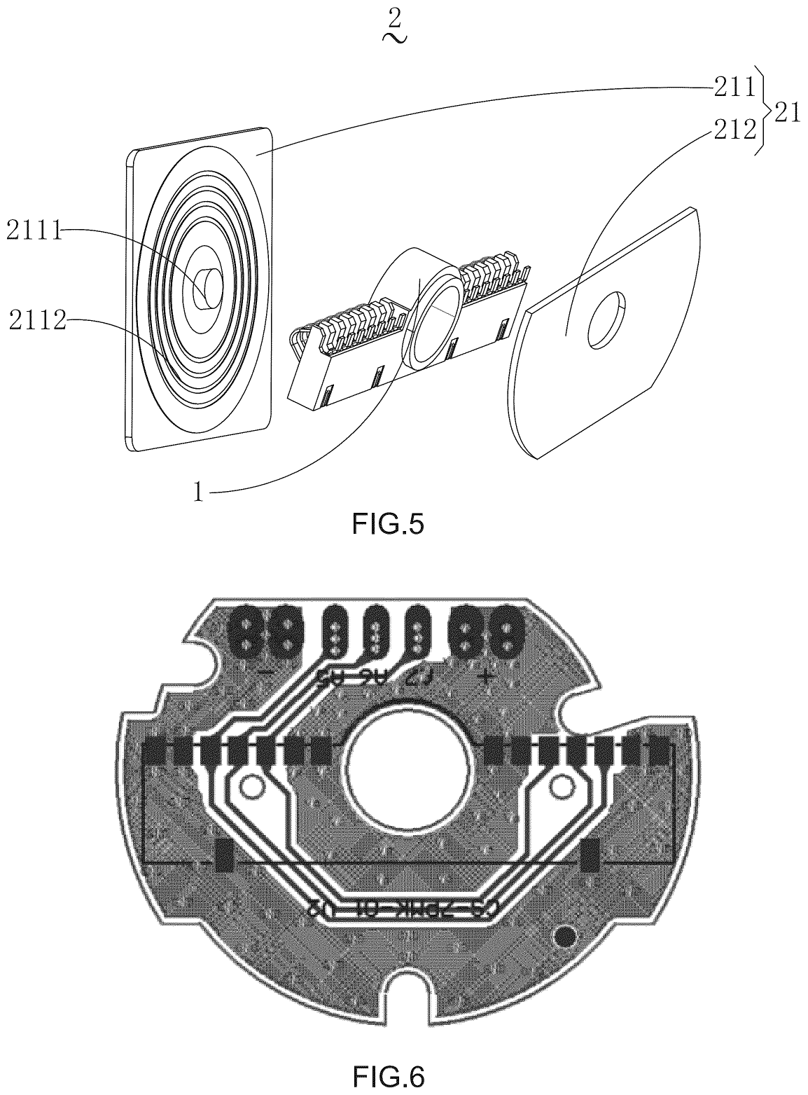

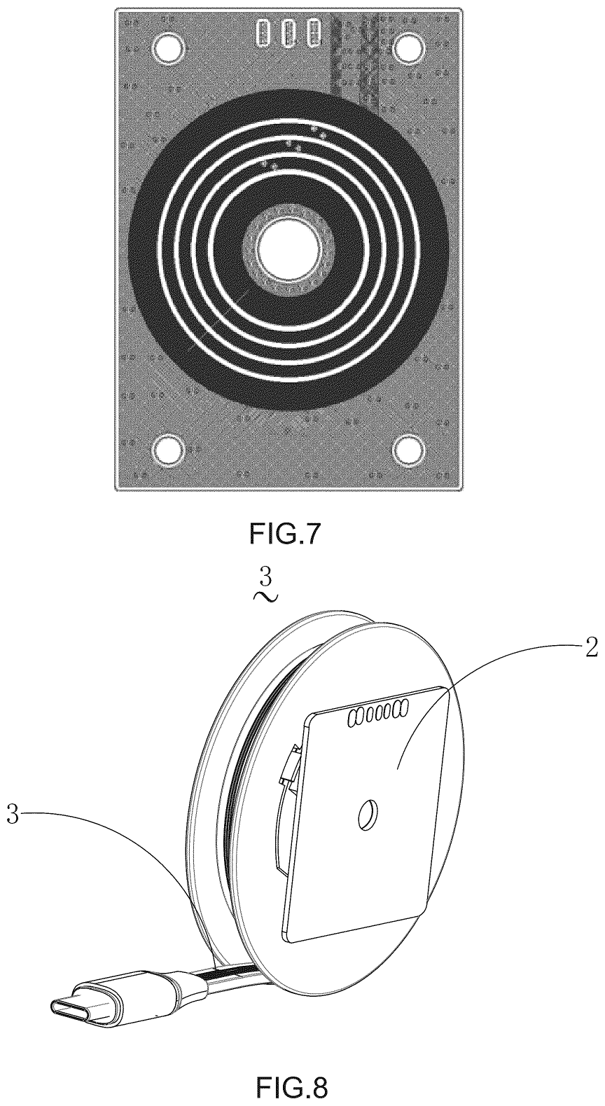

Specifically, please refer to FIG. 6 and FIG. 7. FIG. 6 is a schematic diagram of the circuit of the second limit plate, and FIG. 7 is a schematic diagram of the circuit of the first limit plate.

It can be understood that, through the above arrangement, when the plane slip ring 1 rotates, the conductive member 12 can move in the slide groove 2112, and always maintain an electrical connection with the bottom of the slide groove 2112, so as to facilitate the transmission of electrical signals.

Please refer to FIG. 8. The present disclosure further provides a telescopic data cable assembly 3 to solve the technical problem, including the rotating conductive assembly 2 as described above. The telescopic data cable assembly 3 also includes a data cable 31 electrically connected to the rotating conductive assembly 2. When the data cable 31 is stretched, the plane slip ring in the rotating conductive assembly 2 is driven to rotate. The telescopic data cable assembly 3 has the same beneficial effects as the rotating conductive assembly 2 as described above, which will not be described in detail here.

The above description is only a preferred embodiment of the present disclosure and is not intended to limit the present disclosure. Any modifications, equivalent substitutions and improvements made within the principles of the present disclosure should be included in the protection scope of the present disclosure.

1. A plane slip ring, used for ensuring stable electrical connection with a PCB during rotation, comprising:
a structural support and a plurality of conductive members arranged on the structural support;
the structural support comprising a limit ring and an extension section extending radially symmetrically along the limit ring, and the conductive member being arranged on the extension section;
each conductive member comprising a contact portion for electrical contact with other external components, a contact point being formed on the contact portion, and the contact points of the conductive members being coplanar and located on a same straight line.

2. The plane slip ring of claim 1, wherein the extension section comprises at least two sections, which are axially symmetrical or centrally symmetrical on both sides of the limit ring.

3. The plane slip ring of claim 2, wherein a total quantity of the extending sections is an even number.

4. The plane slip ring of claim 1, wherein the conductive members are evenly spaced and arranged on a same side of the extending section along an axial direction of the limit ring.

5. The plane slip ring of claim 4, wherein the conductive members are symmetrically arranged on the extension section.

6. The plane slip ring of claim 1, wherein the plane slip ring further comprises a plurality of pins electrically connected to the conductive members, and the extension section is provided with a plurality of receiving grooves for accommodating the conductive members and the pins.

7. The plane slip ring of claim 6, wherein the conductive members and the pins are embedded in the receiving grooves and both partially protrude from the receiving grooves.

8. The plane slip ring of claim 7, wherein one end of the conductive member is embedded in the receiving groove, and the other end thereof is overhead with the contact portion, and an overhead end of the conductive member is received in the receiving groove.

9. The plane slip ring of claim 6, wherein each pair of pins and conductive members that are electrically connected are integrally formed or spliced together.

10. The plane slip ring of claim 1, wherein the conductive member is partially bent to form the contact portion, and an abutment structure is arranged on a curved surface of each contact portion; the abutment structure forms the contact point at a position where the curved surface is in electrical contact with other external components.

11. The plane slip ring of claim 10, wherein the contact portion is in a form of an arc, the arc is bent away from the extending section, and the abutment structure is arranged on an arc surface of each contact portion.

12. The plane slip ring of claim 1, wherein one side of the limit ring close to the conductive member protrudes from the structural support, and a protruding height thereof is less than a height of a vertex of the contact portion of the conductive member.

13. The plane slip ring of claim 1, wherein an annular protrusion that forms a concentric ring structure with the limit ring is provided on a side of the limit ring away from the conductive member forming the contact portion.

14. The plane slip ring of claim 13, wherein an outer diameter of the annular protrusion is less than an outer diameter of the limit ring.

15. The plane slip ring of claim 13, wherein a side wall defining the limit ring and the annular protrusion close to the conductive member is an outer side wall, and a side wall defining the limit ring and opposite to the outer side wall is an inner side wall; the inner side wall of the annular protrusion is in a same plane as the inner side wall of the limit ring, and a thickness between the inner and outer side walls of the annular protrusion is less than a thickness between the inner and outer side walls of the limit ring; the annular protrusion is arranged close to the inner side wall of the limit ring, such that the inner side wall of the annular protrusion and the inner side wall of the limiting ring are in the same plane.

16. The plane slip ring of claim 1, wherein the structural support is further provided with a partition plate, and the partition plate is used to limit an interval at which the conductive members are arranged and a position of the limit ring and the conductive member.

17. A rotating conductive assembly, comprising the plane slip ring of claim 1 and a limit plate adapted to the plane slip ring, wherein the limit plate is provided with a limit protrusion adapted to the limit ring, and the plane slip ring can complete rotation through cooperation between the limit ring and the limit protrusion.

18. The rotating conductive assembly of claim 17, wherein the limit plate comprises a first limit plate and a second limit plate, and the plane slip ring is arranged on the second limit plate and rotates in cooperation with the first limit plate via the limit ring.

19. The rotating conductive assembly of claim 18, wherein the first limit plate is provided with a slide groove corresponding to the contact portion of the conductive member, the slide groove is formed along a rotation trajectory of a corresponding conductive member, and the conductive member abuts against and is electrically connected to a bottom of the slide groove.

20. A telescopic data cable assembly, comprising the rotating conductive assembly of claim 19 and a data cable electrically connected to the rotating conductive assembly, wherein when the data cable is stretched, the plane slip ring in the rotating conductive assembly is driven to rotate.
